(19) United States
(12) Patent Application Publication
(10) Pub. No.: US 2020/0231504 A1
(43) Pub. Date: Jul. 23, 2020

(54) METHOD FOR SYNERGISTIC STABILIZATION/SOLIDIFICATION OF RED MUD AND PHOSPHOGYPSUM

(71) Applicant: KUNMING UNIVERSITY OF SCIENCE AND TECHNOLOGY, KUNMING CITY (CN)

(72) Inventors: PING NING, KUNMING CITY (CN); YU LIU, KUNMING CITY (CN); BIN LI, KUNMING CITY (CN); YINGJIE ZHANG, KUNMING CITY (CN); PENG DONG, KUNMING CITY (CN); JIANG QI, KUNMING CITY (CN)

(73) Assignee: KUNMING UNIVERSITY OF SCIENCE AND TECHNOLOGY

(21) Appl. No.: 16/749,105

(22) Filed: Jan. 22, 2020

(30) Foreign Application Priority Data
Jan. 23, 2019 (CN) 201910061238.8

(51) Int. Cl. C04B 28/14; C04B 18/04; C04B 24/26; C04B 24/18; C04B 24/12; C04B 14/08; C04B 14/04

(52) U.S. Cl. CPC C04B 28/143; C04B 18/0409; C04B 24/2652; C04B 14/043; C04B 24/2641; C04B 24/122; C04B 14/08; C04B 24/18

(57) ABSTRACT

The present invention discloses a method for synergistic stabilization/solidification of red mud and phosphogypsum. The method includes: grinding and mixing red mud and phosphogypsum, adding deionized water, uniformly stirring the mixture to prepare slurry, adjusting a pH value of the slurry to 7.5-8.5, adding a conditioner and conducting stirring, adding a stabilizer and an anti-permeability agent, uniformly stirring the mixture to obtain a gel product, and conducting solidification for 12-24 h to solidify the red mud and phosphogypsum, to obtain a red mud-phosphogypsum solidified material. In the present invention, the neutralization reaction between acidic ions in phosphogypsum and basic ions in red mud is adopted to reduce a pH value of the red mud and a transfer capability of pollutants in waste residues; synergistic solidification processing is conducted on two types of solid wastes: red mud produced in the aluminum smelting industry and phosphogypsum produced in the phosphorus chemical industry.

### TECHNICAL FIELD

The present invention belongs to the technical field of environmental protection, relates to the field of solid waste emission reduction in the phosphorus chemical industry and aluminum chemical industry, and particularly to a method for synergistic stabilization/solidification of red mud and phosphogypsum.

### BACKGROUND

Red mud is an industrial solid waste discharged after alumina is extracted from bauxite. According to different production methods, the red mud can be divided into sintering red mud, Bayer red mud, and combined red mud. When 1 ton of aluminum oxide is produced, approximately 1-2 tons of red mud will be produced. The harm of red mud mainly results from its high alkalinity. The stockpiling of a large amount of red mud will easily cause salinization of surrounding soil, pollute the groundwater and surrounding environment, and deteriorate the ecological environment, thereby resulting in safety risks.

Phosphogypsum is a solid waste discharged during the production of phosphate fertilizer and. phosphoric acid. The phosphogypsum mainly contains calcium sulfate, and also contains a small amount of phosphoric acid, silicon, magnesium, iron, aluminum, sulfuric acid, fluorine, organic impurities, etc. Main hazardous substances in the phosphogypsum include water-soluble fluorine and free acid. When 1 ton of phosphoric acid is produced, approximately 4.5-5 tons of phosphogypsum will be produced. A large amount of phosphogypsum is produced in China every year. The stockpiling of a large amount of phosphogypsum not only occupies land, but also leads to water, soil, and other environmental pollution.

A stabilization/solidification method is a technology for preventing or reducing the release of harmful chemical substances from waste residues. An additive is used to change engineering characteristics of the waste residues, to change physical and chemical properties of the waste residues. In this way, a pollutant in the waste residues can be changed into an insoluble form with lower migration capability and toxicity. There have been a lot of researches on separate stabilization/solidification of phosphogypsum, red mud, etc. at home and abroad. However, there is no effective way for the large-scale application thereof. Red mud and phosphogypsum have become a main technical bottleneck restricting the development of the two industries. In addition, these two types of waste residues are both recyclable resources with useful values. However, due to alkaline components in the red mud and acidic components in the phosphogypsum, their comprehensive utilization is low, and it is difficult to solidify the red mud and phosphogypsum. Moreover, and valuable components therein have not been effectively used. As a result, both environmental pollution and a waste of resources are caused. Therefore, it is necessary to conduct research on a new stabilization/solidification method, to resolve the stockpiling problem of red mud and phosphogypsum and effectively utilize resources, which has become one of urgent tasks in the alumina industry and phosphorus chemical industry at home and abroad.

### SUMMARY

To overcome the deficiencies in the prior art, the present invention provides a method for synergistic stabilization/solidification of red mud and phosphogypsum. The present invention resolves the environmental problem resulting from the stockpiling of a large amount of these two types of waste residues: red mud and phosphogypsum. A mixed solidified material obtained finally can also be used as a cement retarder.

A method for synergistic stabilization/solidification of red mud and phosphogypsum is provided, including the following specific steps:

grinding and mixing red mud and phosphogypsum, adding deionized water, uniformly stirring the mixture to prepare slurry, adjusting a pH value of the slurry to 7.5-8.5, adding a conditioner and conducting stirring, adding a stabilizer and an anti-permeability agent, uniformly stirring the mixture to obtain a gel product, and conducting solidification for 12-24 h to solidify the red mud and phosphogypsum, to obtain a red mud-phosphogypsum solidified material.

To increase a surface area of solid particles contained in the red mud-phosphogypsum solidified material and reduce the sizes of solid materials, the red mud and phosphogypsum need to be grinded, to make particle sizes of solid particles of both the red mud and phosphogypsum less than or equal to 10 mm.

The red mud is Bayer red mud, and the phosphogypsum is an industrial residue produced during the preparation of phosphoric acid.

The red mud and phosphogypsum are mixed according to a mass ratio of 1:3-1:7.

The conditioner is a gel material, which is a type of aluminosilicate bonding material prepared by the following steps: drying a natural aluminosilicate mineral or an industrial aluminum-silicon material as a raw material for 1 h in an electrothermal constant temperature blast drying oven, conducting calcination in a muffle furnace at 500-900° C. for 2 h, cooling, and grinding an obtained product into fine powder with a specific surface area of 350-450 m²/Kg; and mixing the fine powder with a NaOH solution with a concentration of 3-5 mol/L according to a mass ratio of (2.5-3):1, and conducting the dehydration-condensation reaction of the fine powder for 1-2 h under the excitation of the NaOH solution. The natural aluminosilicate mineral includes fly ash, kaoline, iron industry slag, etc, and the industrial aluminum-silicon material includes aluminum-silicon thermal insulation fire clay.

An addition amount of the conditioner is 9%-11% of a total mass of the red mud and phosphogypsum.

The stabilizer is one of sodium polyacrylate, calcium lignin sulfonate, and polyacrylamide or a mixture of several of sodium polyacrylate, calcium lignin sulfonate, and polyacrylamide at any ratio.

An addition amount of the stabilizer is 2%-4% of a total mass of the red mud and phosphogypsum.

The anti-permeability agent is triethanolamine or diatomite.

An addition amount of the anti-permeability agent is 0.5%-1.5% of a total mass of the red mud and phosphogypsum.

Beneficial effects of the present invention are as follows:

1. In the present invention, the red mud and phosphogypsum as main raw materials are mixed, and then a specific amount of additives is added. A synergistic effect between various components is used to solidify metal ions in red mud-phosphogypsum and reduce transfer and transformation of pollutants, thereby resolving the environmental problem resulting from the stockpiling of a large amount of red mud and phosphogypsum. Main hazardous substances in phosphogypsum include water-soluble fluorine and free acid. Ca(OH)₂ in red mud and hydrated silicoaluminate can neutralize soluble phosphorus and fluorine in phosphogypsum, to produce insoluble minerals such as calcium phosphate, sodium fluosilicate, and calcium sulfate. In this way, a dissolution rate of fluorine in water and water-soluble phosphorus in the phosphogypsum can be reduced. This reduces the harm of acidic and alkali substances in waste residues to the environment. Because the red mud contains calcium with a bonding effect, the red mud can absorb a part of attached water in the phosphogypsum residue, thereby reducing the water content of the phosphogypsum. In addition, the phosphogypsum can activate an active substance in the red mud to stabilize harmful ions in the red mud.

2. In the present invention, due to the combination of the conditioner and the red mud-phosphogypsum mixture, physical and chemical properties of the red mud and phosphogypsum are changed. In this case, more hydration products are produced, and a cementation effect is enhanced, so as to reduce permeability coefficients of the wastes and enhance the internal mechanical strength thereof. Alkalis in the red mud exist in forms of Na₂CO₃, NaOH, sodium aluminosilicate, and Ca(OH)₂. These substances can provide OW in an aqueous medium to prompt hydration of aluminosilicate in the conditioner. Active substances silicon dioxide and aluminum oxide in the red mud can also react with Ca(OH)₂ to obtain products such as calcium silicate hydrate and calcium aluminate hydrate, so that the solidified material has a specific bearing capability. Moreover, calcium silicate hydrate gel and calcium aluminate hydrate in the conditioner can be used as a “binder” to bind various components into a whole, faulting a solidified product with compressive strength. Unhydrated particles and insoluble substances in the slurry can be filled in the red mud-phosphogypsum solidified material. This reduces the porosity of the solidified material and improves the compactness of the solidified material. When the aluminosilicate mineral in the conditioner is corroded by an strong alkali, network modifiers such as Ca²⁺, K⁺, and Na⁺ are rapidly dissolved in the solution. As a result, formed network systems such as silicate or aluminate structures are gradually depolymerized to release —Si—O—Si— and —Si—O—Al— prepolymers. These prepolymers are dehydrated, condensed, cemented, and hardened to form dense aluminosilicate polymeric materials. These new gel products can cement and solidify the red mud and phosphogypsum. Moreover, the conditioner can ensure that the solidified material has sufficient water stability. Therefore, the solidified material cannot be rotted and loosed in the production and stockpiling processes when being subjected to rainwater soaking.

3. The stabilizer in the present invention is one of sodium polyacrylate, calcium lignin sulfonate, and polyacrylamide or a mixture of several of sodium polyacrylate, calcium lignin sulfonate, and polyacrylamide at any ratio. The stabilizer can improve glutinousness of the slurry mixture, and prevent a cementing material from being solidified instantly. In addition, the stabilizer can make impurity particles in the shiny become unstable and condensed to form larger particles.

4. In the present invention, the main raw materials are waste residues, so as to achieve an objective of using waste to treat waste. The method has simple operations, low costs, and no secondary pollution.

5. A solidification rate of the red mud-phosphogypsum solidified material obtained in the present invention can reach above 90%. The present invention resolves the problems of air, water, soil, and surrounding environment pollution resulting from the stockpiling of red mud and phosphogypsum, so as to implement the sustainable development of the aluminum industry and the phosphorus chemical industry. This also lays a good foundation for the comprehensive utilization of these two types of industrial waste residues, and has very important environmental protection significance and economic benefits.

### DETAILED DESCRIPTION

The present invention is further described below with reference to specific embodiments.

### Embodiment 1

A method for synergistic stabilization/solidification of red mud and phosphogypsum is provided, including the following specific steps:

(1) Grind red mud and phosphogypsum, where the grinding operation is conducted to increase a surface area of solid particles contained in a red mud-phosphogypsum solidified. material and reduce the sizes of solid materials of the red mud and phosphogypsum, to make particle sizes of solid particles of the red mud and phosphogypsum less than or equal to 10 mm; the red mud is Bayer red mud, and the phosphogypsum is an industrial residue produced during the preparation of phosphoric acid.

(2) Mix the red mud and phosphogypsum in step (1) at a mass ratio of 1:4, add deionized water, uniformly stir the mixture to prepare slurry, adjust a pH value of the shiny mixture to 8 with dilute sulfuric acid; and add a conditioner accounting for 9% of a total mass of the red mud and phosphogypsum, where the conditioner is a gel material, which is a type of aluminosilicate bonding material prepared by the following steps: drying a natural aluminosilicate mineral fly ash as a raw material for 1 h in an electrothermal constant temperature blast drying oven, conducting calcination in a muffle furnace at 500° C. for 2 h, cooling, and grinding an obtained product into fine powder with a specific surface area of 350 m²/Kg; and mixing the fine powder with a NaOH solution with a concentration of 5 mol/L according to a mass ratio of 2.5:1, and conducting the dehydration-condensation reaction of the fine powder for 2 h under the excitation of the NaOH solution.

(3) Add, to the slurry in step (2), polyacrylamide accounting for 3% of the total mass of the red mud and phosphogypsum as a stabilizer and triethanolamine accounting for 1% of the total mass of the red mud and phosphogypsum as an anti-permeability agent, uniformly mix the mixture, and conduct solidification at room temperature for 20 h, to obtain a red mud-phosphogypsum solidified material.

It can be learned through measurement that a concentration of water-soluble fluoride in the solidified material is 8.75 mg/L, and a solidification rate can reach 93%. The water-soluble fluoride is measured in accordance with the environmental standard of the People's Republic of China: solid waste-extraction procedure for leaching toxicity-sulfuric acid & nitric acid method (HJ/T299-2007). A concentration of water-soluble fluorine in unsolidified. phosphogypsum is 125 mg/L, and exceeds 100 mg/m² specified in the State Standard of the People's Republic of China: Identification standards for hazardous wastes-Identification for extraction toxicity (GB5085.3-2007), the same below.

### Embodiment 2

A method for synergistic stabilization/solidification of red mud and phosphogypsum is provided, including the following specific steps:

(1) Grind red mud and phosphogypsum, where the grinding operation is conducted to increase a surface area of solid particles contained in a red mud-phosphogypsum solidified material and reduce sizes of solid materials of the red mud and phosphogypsum, to make particle sizes of solid particles of the red mud and phosphogypsum less than or equal to 10 mm; the red mud Bayer red mud, and the phosphogypsum is an industrial residue produced during the preparation of phosphoric acid.

(2) Mix the red mud and phosphogypsum in step (1) at a mass ratio of 1:7, add deionized water, uniformly stir the mixture to prepare slurry, adjust a pH value of the slurry mixture to 7 with dilute sulfuric acid; and add a conditioner accounting for 10% of a total mass of the red mud and phosphogypsum, where the conditioner is a gel material, which is a type of aluminosilicate bonding material prepared by the following steps: drying a natural aluminosilicate mineral kaolin as a raw material for 1I h in an electrothermal constant temperature blast drying oven, conducting calcination in a muffle furnace at 900° C. for 2 h, cooling, and grinding an obtained product into fine powder with a specific surface area of 400 m² Kg; and mixing the fine powder with a NaOH solution with a concentration of 3 mol/L according to a mass ratio of 2.5:1, and conducting dehydration-condensation reaction of the fine powder for 1 h under the excitation of the NaOH solution.

(3) Add, to the slurry in step (2), calcium lignin sulfonate accounting for 4% of the total mass of the red mud and phosphogypsum as a stabilizer and diatomite accounting for 0.5% of the total mass of the red mud and phosphogypsum as an anti-permeability agent, uniformly mix the mixture, and conduct solidification at morn temperature for 12 h, to obtain a red mud-phosphogypsum solidified material. It can be learned through measurement that, a concentration of water-soluble fluoride in the solidified material is 12.5 mg/L, and a solidification rate can reach 90%.

### Embodiment 3

A method for synergistic stabilization/solidification of red mud and phosphogypsum is provided, including the following specific steps:

(1) Grind red mud and phosphogypsum, where the grinding operation is conducted to increase a surface area of solid particles contained in a red mud-phosphogypsum solidified material and reduce sizes of solid materials in a mixture of the red mud and phosphogypsum, to make particle sizes of solid particles of the red mud and phosphogypsum less than or equal to 10 mm; the red mud is Bayer red mud, and the phosphogypsum is an industrial residue produced during the preparation of phosphoric acid.

(2) Mix the red mud and phosphogypsum in step (1) at a mass ratio of 1:5, add &ionized water, uniformly stir the mixture to prepare slurry, adjust a pH value of the shiny mixture to 7.5 with dilute sulfuric acid; and add a conditioner accounting for 11% of a total mass of the red mud and phosphogypsum, where the conditioner is a gel material, which is a type of aluminosilicate bonding material prepared by the following steps: drying a natural aluminosilicate mineral: iron industry slag as a raw material for 1 h in an electrothermal constant temperature blast drying oven, conducting calcination in a muffle furnace at 800° C. for 2 h, cooling, and grinding an obtained product into fine powder with a specific surface area of 450 m²/Kg; and mixing the fine powder with a NaOH solution with a concentration of 4 mol/L according to a mass ratio of 2.8:1, and conducting dehydration-condensation reaction of the fine powder for 1.5 h under the excitation of the NaOH solution.

(3) Add, to the slurry in step (2), polyacrylamide accounting for 3% of the total mass of the red mud and phosphogypsum as a stabilizer and triethanolamine accounting for 1% of the total mass of the red mud and phosphogypsum as an anti-permeability agent, uniformly mix the mixture, and conduct solidification at room temperature for 20 h, to obtain a red mud-phosphogypsum solidified material. It can be learned through measurement that a concentration of water-soluble fluoride in the solidified. material is 2.5 mg/L, and a solidification rate can reach 98%.

Embodiment 4

A method for synergistic stabilization/solidification of red mud and phosphogypsum is provided, including the following specific steps:

(1) Grind red mud and phosphogypsum, where the grinding operation is conducted to increase a surface area of solid particles contained in a red mud-phosphogypsum solidified material and reduce sizes of solid materials in a mixture of the red mud and phosphogypsum, to make particle sizes of solid particles of the red mud and phosphogypsum less than or equal to 10 mm; the red mud is Bayer red mud, and the phosphogypsum is an industrial residue produced during the preparation of phosphoric acid.

(2) Mix the red mud and phosphogypsum in step (1) at a mass ratio of 1:6, add deionized water, uniformly stir the mixture to prepare slurry, adjust a pH value of the slurry mixture to 7.5 with dilute sulfuric acid; and add a conditioner accounting for 10% of a total mass of the red mud and phosphogypsum, where the conditioner is a gel material, which is a type of aluminosilicate bonding material prepared by the following steps: drying a natural aluminosilicate mineral: kaolin as a raw material for 1 h in an electrothermal constant temperature blast drying oven, conducting calcination in a muffle furnace at 700° C. for 2 h, cooling, and grinding an obtained product into fine powder with a specific surface area of 350 m²/Kg; and mixing the fine powder with a NaOH solution with a concentration of 4 mol/L according to a mass ratio of 2.5:1, and conducting dehydration-condensation reaction of the fine powder for 2 h under the excitation of the NaOH solution.

(3) Add, to the slurry in step (2), sodium polyacrylate accounting for 3.5% of the total mass of the red mud and phosphogypsum as a stabilizer and triethanolamine accounting for 1.2% of the total mass of the red mud and phosphogypsum as an anti-permeability agent, uniformly mix the mixture, and conduct solidification at room temperature for 24 h, to obtain a red mud-phosphogypsum solidified material. It can be learned through measurement that a concentration of water-soluble fluoride in the solidified material is 6.25 mg/L, and a solidification rate can reach 95%.

Embodiment 5

A method for synergistic stabilization/solidification of red mud and phosphogypsum is provided, including the following specific steps:

(1) Grind red mud and phosphogypsum, where the grinding operation is conducted to increase a surface area of solid particles contained in a red mud-phosphogypsum solidified material and reduce sizes of solid materials in a mixture of the red mud and phosphogypsum, to make particle sizes of solid particles of the red mud and phosphogypsum less than or equal to 10 mm; the red mud is Bayer red mud, and the phosphogypsum is an industrial residue produced during the preparation of phosphoric acid.

(2) Mix the red mud and phosphogypsum in step (1) at a mass ratio of 1:3, add deionized water, uniformly stir the mixture to prepare slurry, adjust a pH value of the shiny mixture to 8.5 with a dilute sodium hydroxide solution; and add a conditioner accounting for 9% of a total mass of the red mud and phosphogypsum, where the conditioner is a gel material, which is a type of aluminosilicate bonding material prepared by the following steps: drying an industrial aluminum-silicon material: aluminum-silicon thermal insulation fire clay as a raw material for 1 h in an electrothermal constant temperature blast drying oven, conducting calcination in a muffle furnace at 800° C. for 2 h, cooling, and grinding an obtained product into fine powder with a specific surface area of 400 m²/Kg; and mixing the fine powder with a NaOH solution with a concentration of 5 mol/L according to a mass ratio of 3:1, and conducting dehydration-condensation reaction of the fine powder for 1 h under the excitation of the NaOH solution.

(3) Add, to the slurry in step (2), a mixture, accounting for 3.5% of the total mass of the red mud and phosphogypsum as a stabilizer, of sodium polyacrylate and polyacrylamide at a mass ratio of 1:2 and triethanolamine accounting for 1.5% of the total mass of the red mud and phosphogypsum as an anti-permeability agent, uniformly mix the mixture, and conduct solidification at room temperature for 24 h, to obtain a red mud-phosphogypsum solidified material. It can be learned through measurement that a concentration of water-soluble fluoride in the solidified material is 11.25 mg/L, and a solidification rate can reach 91%.

### Comparative Example

Red mud and phosphogypsum are grinded, where the grinding operation is conducted to increase a surface area of solid particles contained in a red mud-phosphogypsum solidified material and reduce sizes of solid materials in a mixture of the red mud and phosphogypsum, to make particle sizes of solid particles of the red mud and phosphogypsum less than or equal to 10 mm; the red mud is Bayer red mud, and the phosphogypsum is an industrial residue produced during the preparation of phosphoric acid. The red mud and phosphogypsum were mixed at a mass ratio of 1:7, and uniformly stirred; water was added to prepare slurry; and the slurry is molded and solidified for 20 h, to obtain a red mud-phosphogypsum solidified material It can be learned through measurement that a concentration of water-soluble fluoride in the solidified material is 80 mg/L, and a solidification rate is 36%.

It can be learned through comparing Embodiments 1 to 5 with Comparative Example in this specification that, the solidified material prepared after directly mixing the red mud and phosphogypsum has high-content water-soluble fluorine and a low solidification rate. Moreover, the long-time stockpiling of the solidified material will easily result in environmental pollution. Therefore, Embodiments 1-5 are superior to Comparative Example.

What is claimed is:

1. A method for synergistic stabilization/solidification of red mud and phosphogypsum, comprising the following specific steps:
grinding and mixing red mud and phosphogypsum, adding deionized water, uniformly stirring the mixture to prepare slurry, adjusting a pH value of the slurry to 7.5-8.5, adding a conditioner and conducting stirring, adding a stabilizer and an anti-permeability agent, uniformly stirring the mixture, and conducting solidification for 12-24 h, to obtain a red mud-phosphogypsum solidified material.

2. The method for synergistic stabilization/solidification of red mud and phosphogypsum according to claim 1, wherein particle sizes of both the red mud and phosphogypsum are less than or equal to 10 mm.

3. The method for synergistic stabilization/solidification of red mud and phosphogypsum according to claim 1, wherein the red mud is Bayer red mud, and the phosphogypsum is an industrial residue produced during the preparation of phosphoric acid.

4. The method for synergistic stabilization/solidification of red mud and phosphogypsum according to claim 1, wherein the red mud and phosphogypsum are mixed according to a mass ratio of 1:3-1:7.

5. The method for synergistic stabilization/solidification. of red mud and phosphogypsum according to claim 1, wherein the conditioner is prepared by the following steps: drying a natural aluminosilicate mineral or an industrial aluminum-silicon material, conducting calcination at 500-900° C. for 2 h cooling, and grinding an obtained product into fine powder with a specific surface area of 350-450 m²/Kg; and mixing the fine powder with a NaOH solution with a concentration of 3-5 mol/L according to a mass ratio of (2.5-3):1, and allowing reaction at 20-120° C. for 1-2 h.

6. The method for synergistic stabilization/solidification of red mud and phosphogypsum according to claim 1, wherein an addition amount of the conditioner is 9%-11% of a total mass of the red mud and phosphogypsum.

7. The method for synergistic stabilization/solidification of red mud and phosphogypsum according to claim 1, wherein the stabilizer is one of sodium polyacrylate, calcium lignin sulfonate, and polyacrylamide or a mixture of several of sodium polyacrylate, calcium lignin sulfonate, and polyacrylamide at any ratio.

8. The method for synergistic stabilization/solidification of red mud and phosphogypsum according to claim 1, wherein an addition amount of the stabilizer is 2%-4% of a total mass of the red mud and phosphogypsum.

9. The method for synergistic stabilization/solidification of red mud and phosphogypsum according to claim 1, wherein the anti-permeability agent is triethanolamine or diatomite.

10. The method for synergistic stabilization/solidification of red mud and phosphogypsum according to claim 1, wherein an addition amount of the anti-permeability agent is 0.5%-1.5% of a total mass of the red mud and phosphogypsum.
